(19) United States
(12) Patent Application Publication
(10) Pub. No.: US 2009/0189936 A1
(43) Pub. Date: Jul. 30, 2009

(54) HEAD UNIT AND LIQUID EJECTING METHOD

(75) Inventor: Noboru TAMURA, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/360,472

(22) Filed: Jan. 27, 2009

(30) Foreign Application Priority Data
Jan. 28, 2008 (JP) 2008-016699

(51) Int. Cl. B41J 29/38

(52) U.S. Cl. 347/12

(57) ABSTRACT

A head unit includes: a first nozzle group which has a plurality of nozzles ejecting liquid droplets onto a medium to form an image; a second nozzle group which has a plurality of nozzles which do not eject liquid droplets onto the medium, while the nozzles of the first nozzle group eject the liquid droplets onto the medium to form the image; and a controller which determines whether to eject the liquid droplets from each of the nozzles of the first nozzle group on the basis of data individually corresponding to the nozzles of the first nozzle group and which commonly determines whether to eject the liquid droplets from the nozzles of the second nozzle group on the basis of data commonly corresponding to the nozzles of the second nozzle group.

### BACKGROUND

1. Technical Field

The present invention relates to a head unit and a liquid ejecting method.

2. Related Art

An ink jet printer which ejects ink droplets on a medium to form an image is known. This ink jet printer forms an image by ejecting ink droplets from a plurality of nozzles.

The nozzles ejecting ink droplets are arranged in one nozzle row or a plurality of nozzle rows. However, in some cases, the nozzles in ends of the nozzle row have a characteristic of ink droplets ejection which is different from that in the other nozzles due to various causes. For that reason, upon forming an image, the several nozzles in the ends of the nozzle row are configured not to be used.

However, when the several nozzles in the ends of the nozzle row are configured not to be used upon forming an image, the ink droplets may be adhered to the nozzles due to dryness, thereby clogging the nozzles. Since the several nozzles in the ends of the nozzle row are not used upon forming an image, a problem does not occurs even though the nozzles are clogged. However, the characteristic of ink droplet ejecting of nozzles adjacent to the clogged nozzles may deteriorate due to various causes. In order to avoid this problem, it is necessary to perform a flushing process of ejecting ink droplets from the whole nozzles in addition to the nozzles in the ends of the nozzle row which are not used in a printing process.

A head unit has a configuration in which both the several nozzles in the ends of the nozzle row which do not eject ink droplets upon forming an image and the nozzles used upon forming the image are capable of ejecting the ink droplets on the basis of pixel data individually corresponding to the nozzles (JP-A-10-81013). In addition, the pixel data instructing that the ink droplets are not ejected from the several nozzles in the ends of the nozzle row are sent in the printing process, and the pixel data instructing that the ink droplets are also ejected from the several nozzles in the ends of the nozzle row are sent in the flushing process.

An example of a known configuration is disclosed in JP-A-5-138884.

However, when the head unit has such a configuration, data individually corresponding to the plurality of nozzles in the ends of the nozzle row is sent to the head unit in order to give an instruction not to eject the ink droplets from the several nozzles in the ends of the nozzle row upon forming an image. That is, the data (which is not used to form an image) which is not actually necessary in the printing process are sent to the head unit. Accordingly, when the data which are not actually necessary are reduced, the amount of data to be sent to the head unit can be reduced.

### SUMMARY

An advantage of some aspects of the invention is that it provides a technique capable of reducing an amount of data to be sent to a head unit.

According to an aspect of the invention, there is provided a head unit including: a first nozzle group which has a plurality of nozzles ejecting liquid droplets onto a medium to form an image; a second nozzle group which has a plurality of nozzles which do not eject liquid droplets onto the medium, while the nozzles of the first nozzle group eject the liquid droplets onto the medium to form the image; and a controller which determines whether to eject the liquid droplets from each of the nozzles of the first nozzle group on the basis of data individually corresponding to the nozzles of the first nozzle group and which commonly determines whether to eject the liquid droplets from the nozzles of the second nozzle group on the basis of data commonly corresponding to the nozzles of the second nozzle group.

Other aspects of the invention are apparent from the specification and the accompanying drawings of the invention.

### BRIEF DESCRIPTION OF THE DRAWINGS

The invention will be described with reference to the accompanying drawings, wherein like numbers reference like elements.

FIG. 1 is an explanatory diagram illustrating the configuration of a printing system.

FIG. 2 is an explanatory block diagram illustrating the configurations of a computer and a printer.

FIG. 3 is a diagram illustrating the configuration of the printer.

FIG. 4 is an explanatory diagram illustrating nozzles provided in a head.

FIG. 5 is an explanatory diagram illustrating the peripheral configuration of a black ink nozzle group and a cyan ink nozzle group.

FIG. 6 is a sectional view illustrating the periphery of two nozzle groups.

FIG. 7 is a block diagram illustrating a head control unit in a reference example.

FIG. 8 is an explanatory diagram illustrating a driving signal and various signals.

FIG. 9A is an explanatory diagram illustrating a setting signal containing pixel data and setting data and FIG. 9B is an explanatory diagram illustrating a function of a selection signal generator.

FIG. 10A is an explanatory diagram illustrating ink flow of pressure chambers and a reservoir of the head and FIG. 10B is an explanatory diagram illustrating ink flow when nozzles are clogged with ink.

FIG. 11 is a block diagram illustrating a head control unit according to a first embodiment.

FIG. 12 is an explanatory diagram illustrating a setting signal containing pixel data and setting data according to the first embodiment.

FIG. 13 is a block diagram illustrating a head control unit according to a second embodiment.

FIG. 14 is an explanatory diagram illustrating a driving signal and various signals according to the second embodiment.

FIG. 15A is an explanatory diagram illustrating a setting signal containing pixel data and setting data according to the second embodiment and FIG. 15B is an explanatory diagram illustrating a function of a selection signal generator according to the second embodiment.

### DESCRIPTION OF EXEMPLARY EMBODIMENTS

Aspects described below are apparent from disclosure of the specification and disclosure of the accompanying drawings of the invention.

According to an aspect of the invention, a head unit includes: a first nozzle group which has a plurality of nozzles ejecting liquid droplets onto a medium to form an image; a second nozzle group which has a plurality of nozzles which do not eject liquid droplets onto the medium, while the nozzles of the first nozzle group eject the liquid droplets onto the medium to form the image; and a controller which determines whether to eject the liquid droplets from each of the nozzles of the first nozzle group on the basis of data individually corresponding to the nozzles of the first nozzle group and which commonly determines whether to eject the liquid droplets from the nozzles of the second nozzle group on the basis of data commonly corresponding to the nozzles of the second nozzle group.

In the head unit having the above configuration, the controller may include switches for the second nozzle group for commonly applying a driving signal to driving elements individually corresponding to the nozzles of the second nozzle group, and the switches for the second nozzle group are commonly controlled on the basis of the data commonly corresponding to the nozzles of the second nozzle group. In addition, the controller may include switches for the first nozzle group for applying a driving signal to driving elements individually corresponding to the nozzles of the first nozzle group, and each of the switches for the first nozzle group is controlled on the basis of the data individually corresponding to the nozzles of the first nozzle group. In addition, the data individually corresponding to nozzles of the first nozzle group and the data commonly corresponding to the nozzles of the second nozzle group may be pixel data. In addition, the data individually corresponding to the nozzles of the first nozzle group may be pixel data, and the data commonly corresponding to the nozzles of the second nozzle group is data contained in setting data used to determine whether a certain waveform in a driving signal is applied to driving elements of the second nozzle group on the basis of the pixel data.

The first nozzle group and the second nozzle group may be arranged in the same nozzle row. In addition, the nozzles of the second nozzle group may be arranged in ends of the same nozzle row. With such a configuration, it is possible to reduce an amount of data to be transmitted to the head unit.

According to another aspect of the invention, a liquid ejecting method includes: determining whether to eject liquid droplets from each of nozzles of a first nozzle group, which eject the liquid droplets onto a medium to form an image, on the basis of data individually corresponding to the nozzles of the first nozzle group, and commonly determining whether to eject liquid droplets from nozzles of a second nozzle group, which do not eject the liquid droplets onto the medium while the nozzles of the first nozzle group form the image, on the basis of data commonly corresponding to the nozzles of the second nozzle group; and ejecting the liquid droplets from the nozzles of the first nozzle group and the nozzles of the second nozzle group on the basis of the determination result. With such a liquid ejecting method, it is possible to reduce an amount of data to be transmitted to the head unit.

### Configuration of Printing System

### Whole Configuration

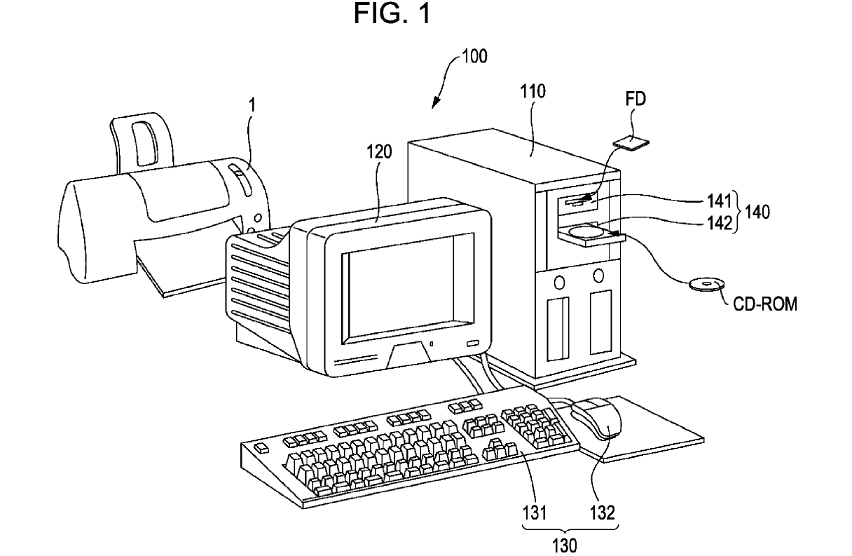

FIG. 1 is an explanatory diagram illustrating the configuration of a printing system 100. The exemplified printing system 100 includes a printer 1, which is a printing apparatus, and a computer 110, which is a printing control apparatus. Specifically, the printing system 100 includes the printer 1, the computer 110, a display apparatus 120, an input apparatus 130, and a record reproducing apparatus 140.

The printer 1 prints an image on a medium such as a sheet, a cloth, or a film. The computer 110 is connected to the printer 1 so as to communicate with each other. In addition, in order to allow the printer 1 to print an image, the computer 110 outputs print data corresponding to the image to the printer 1. Computer programs such as an application program or a printer driver are installed in the computer 110. The display apparatus 120 has a display. The display apparatus 120 is used to display a user interface of the computer programs, for example. The input apparatus 130 includes a keyboard 131 and a mouse 132. The record reproducing apparatus 140 includes a flexible disk drive apparatus 141 and a CD-ROM drive apparatus 142.

### Computer

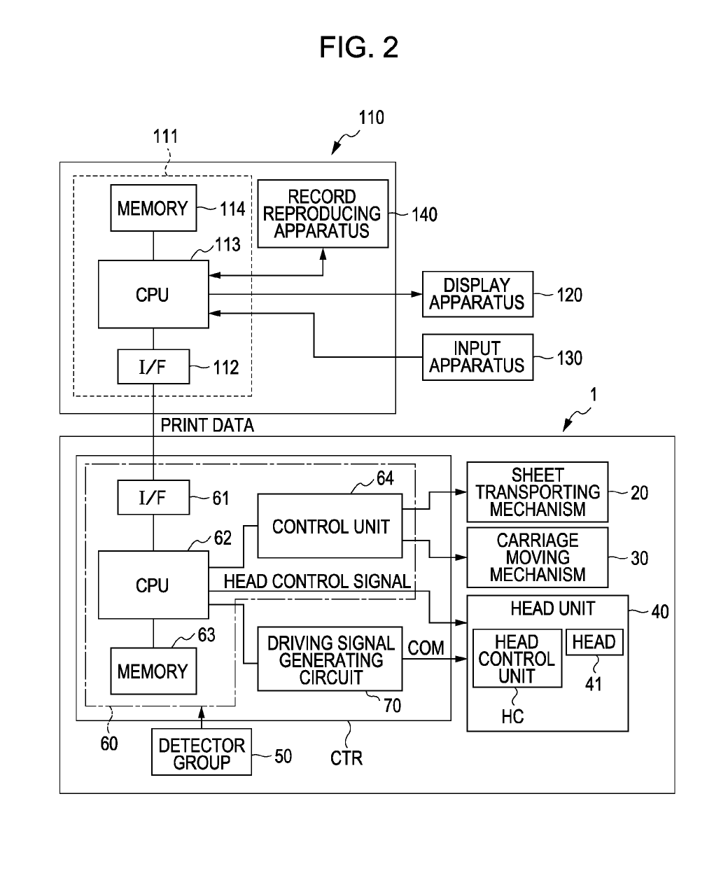

FIG. 2 is an explanatory block diagram illustrating the configurations of the computer 110 and the printer 1. First, the configuration of the computer 110 will be described in brief. The computer 110 includes the above-described record reproducing apparatus 140 and a host controller 111. The record reproducing apparatus 140 is connected to the host controller 111 so as to communicate with each other and attached to a case of the computer 110, for example. The host controller 111 performs various controlling processes in the computer 110. The display apparatus 120 and the input apparatuses 130 described above are also connected so as to communicate with each other. The host controller 111 includes an interface unit 112, a CPU 113, and a memory 114. Data are transmitted to and received from the printer 1 through the interface unit 112. The CPU 113 is an arithmetic processing unit performing a controlling process on the whole in the computer 110. The memory 114 is a unit providing an area where the computer programs to be used by the CPU 113 are stored and a work area. The memory 114 includes a RAM, an EEPROM, a ROM, and a magnetic disk unit. The computer programs stored in the memory 114 includes the application program and the printer driver, as described above. In addition, the CPU 113 performs various controlling processes in accordance with the computer programs stored in the memory 114.

In the computer 110, the printer driver converts image data into print data and transmits the print data to the printer 1. The print data refers to data having a format which is able to be interpreted by the printer 1 and includes various command data and pixel data. The command data refers to data used to instruct the printer 1 to perform a specific process. For example, the command data includes command data instructing a sheet feeding process, command data indicating an amount of transport, and command data instructing a sheet discharging process. In addition, the pixel data refers to data on a pixel of an image to be printed.

Here, the pixel refers to a unit forming an image. The pixels are arranged in a two-dimensional manner to form an image. The pixel data of the print data refers to data (for example, gray scale value) on a dot formed on a sheet S.

The pixel data is constituted by 2-bit data in every pixel. The 2-bit pixel data expresses one pixel with four gray scales.

### Printer

### Configuration of Printer 1

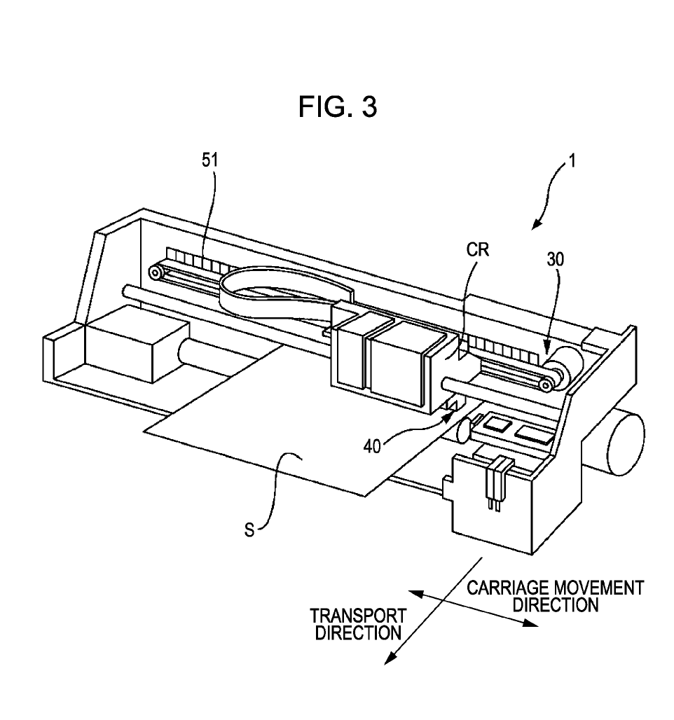

FIG. 3 is a diagram illustrating the configuration of the printer 1 according to embodiments. In addition, description will be made also with reference to FIG. 2.

The printer 1 includes a sheet transporting mechanism 20, a carriage moving mechanism 30, a head unit 40, a detector group 50, a printer controller 60, and a driving signal generating circuit 70. The printer controller 60 and the driving signal generating circuit 70 are provided in a common controller board CTR. In addition, the head unit 40 includes head control units HC and a head 41.

In the printer 1, the printer controller 60 controls controlling targets, that is, the sheet transporting mechanism 20, the carriage moving mechanism 30, the head unit 40 (including the head control units HC and the head 41), and the driving signal generating circuit 70. With such a configuration, the printer controller 60 allows an image to be printed on the sheet S on the basis of the print data received from the computer 110. In addition, each of detectors of the detector group 50 inspects a state of the printer 1. Each of the detector outputs an inspection result to the printer controller 60. The printer controller 60 receiving the inspection result from each of the detector controls the controlling targets on the basis of the inspection result.

The sheet transporting mechanism 20 is a mechanism transporting a medium in a transport direction. The sheet transporting mechanism 20 feeds the sheet S up to a location where the sheet S is printed and transports the sheet S by a predetermined amount of transport in the transport direction. The transport direction refers to a direction intersecting a carriage movement direction.

The carriage moving mechanism 30 is a mechanism moving a carriage CR attached to the head unit 40 in the carriage movement direction. The carriage movement direction refers to both a movement direction from one side to the other side and a movement direction from the other side to the one side. In addition, since the head unit 40 includes the head 41, the carriage movement direction corresponds to a movement direction of the head 41 and the carriage moving mechanism 30 also moves the head 41 in the carriage movement direction.

The head unit 40 is a unit ejecting ink onto the sheet S. The head unit 40 is attached to the carriage CR. The head 41 included in the head unit 40 is provided on a lower surface of a head case. In addition, the head control units HC included in the head unit 40 are provided inside the head case. The head control units HC will be described below in detail.

The detector group 50 is a group of the detectors inspecting the states of the printer 1. The detector group 50 includes a linear type encoder 51 detecting a location in the carriage movement direction of the carriage CR. Moreover, the detector group 50 also includes a sensor (for example, an encoder detecting an amount of rotation of a transporting roller transporting a sheet) detecting an amount of transport of the sheet S.

The printer controller 60 is a unit controlling the printer 1. The printer controller 60 includes an interface unit 61, a CPU 62, a memory 63, and a control unit 64. The interface unit 61 transports and receives data to and from the printer 110 which is an external apparatus. The CPU 62 is an arithmetic processing unit controlling the printer 1 on the whole. The memory 63 is a unit providing an area where programs of the CPU 62 are stored or a work area and includes storage units such as a RAM, an EEPROM, and a ROM. The CPU 62 controls controlling targets in accordance with the computer programs stored in the memory 63. For example, the CPU 62 allows the control unit 64 to control the sheet transporting mechanism 20 or the carriage moving mechanism 30. In addition, the CPU 62 outputs a head control signal to the head control units HC for controlling operations of the head 41 or outputs a generation signal to the driving signal generating circuit 70 for generating a driving signal COM. In a printing process, the printer controller 60 prints an image on the sheet by repeatedly performing a dot forming process of ejecting ink from the head 41 to form dots on the sheet while moving the carriage CR and a transporting process of transporting the sheet by use of the sheet transporting mechanism 20 in an alternative manner.

The driving signal generating circuit 70 is a circuit generating the driving signal COM to be applied to a piezo element 421. The driving signal COM generated by the driving signal generating circuit 70 is input to the head control units HC through cables along with other signals.

### Configuration of Head 41

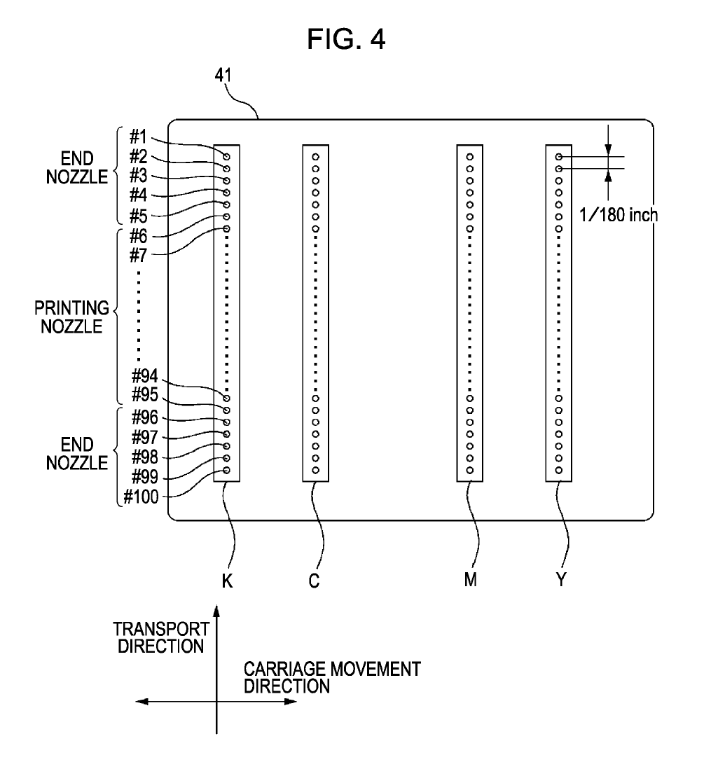

FIG. 4 is an explanatory diagram illustrating nozzles provided in the head 41. A black ink nozzle group K, a cyan ink nozzle group C, a magenta ink nozzle group M, and a yellow ink nozzle group Y are formed on a lower surface of the head 41. Each of the nozzle groups has hundred nozzles which are ejection ports for ejecting each color ink. Each of the nozzles is provided with an ink chamber (not shown) and the piezo element. The ink chamber is contracted and expanded by drive of the piezo element to eject ink droplets from the nozzle. Plural kinds of ink having a different amount can be ejected from the respective nozzles. Accordingly, dots having different sizes can be formed on the sheet.

The hundred nozzles of one nozzle row are classified into end nozzles and print nozzles. The end nozzles are five nozzles arranged from each of ends of a nozzle row. Therefore, among the hundred nozzles, the end nozzles are ten nozzles of #1 to #5 nozzles and #96 to #100 nozzles, and the print nozzles are ninety nozzles of #6 to #95 nozzles.

The end nozzles do not eject the ink droplets to form an image on the sheet. The end nozzles eject the ink droplets only when the flushing process described below is performed. On the other hand, the print nozzles eject the ink droplets to form an image on the sheet. The reason that the end nozzles do not eject the ink droplets to form an image is that ejection precision of the ink droplets in the end nozzles is not good. The reason that the ejection precision is not good will be described below.

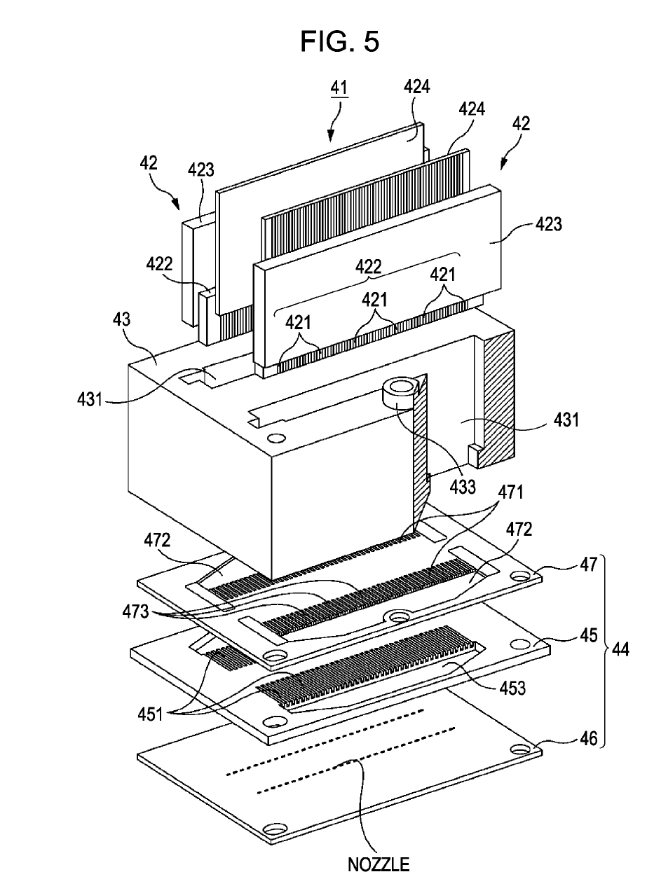

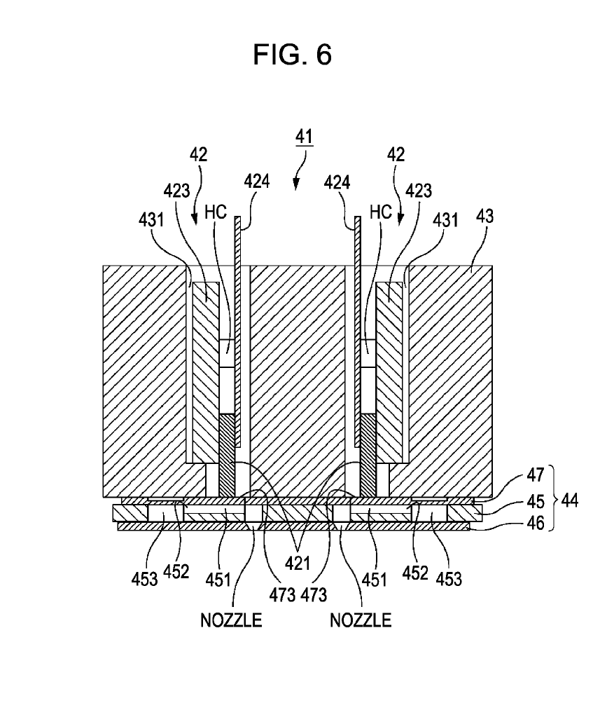

FIG. 5 is an explanatory diagram illustrating the peripheral configuration of the black ink nozzle group K and the cyan ink nozzle group C. FIG. 6 is a sectional view illustrating the periphery of two nozzle groups.

In the periphery of the nozzle groups, a driving unit 42, a case 43 housing the driving unit 42, and a flow passage unit 44 mounted in the case 43 are provided.

The driving unit 42 includes a piezo element group 422 constituted by a plurality of the piezo elements 421, a fixing plate 423 to which the piezo element group 422 is fixed, and a flexible cable 424 feeding electric power to the piezo elements 421. The piezo elements 421 are attached to the fixing plate 423 in a so-called cantilever manner. The fixing plate 423 is a plate-shaped member having rigidity capable of receiving a reactive force from the piezo elements 421. The flexible cable 424 which is a sheet-shaped wiring board having flexibility is electrically connected to the piezo elements 421 on a side surface in a fixation end which is opposed to the fixing plate 423. The head control units HC which are a control IC controlling drive of the piezo elements 421 are mounted on the surface of the flexible cable 424. As illustrated, each of the head control units HC is provided in each of the nozzle groups, that is, each color. The head control units HC will be described in detail below.

The case 43 has an external rectangular block shape with hollow receiving portions 431 which each receive the driving unit 42. The flow passage unit 44 is attached to a front end surface of the case 43. The hollow receiving portion 431 has a size in which the driving unit 42 is exactly fitted. In the case 43, an ink supply pipe 433 used to introduce ink supplied from an ink cartridge to the flow passage unit 44 is formed.

The flow passage unit 44 includes a flow passage forming board 45, a nozzle plate 46, and an elastic plate 47, which are stacked to be incorporated with each other in such a manner that the flow passage forming board 45 is interposed between the nozzle plate 46 and the elastic plate 47. The nozzle plate 46 is a thin plate which is made of stainless steel and in which the nozzles shown in FIG. 4 are formed.

In the flow passage forming board 45, each of empty portions which are a plurality of pressure chambers 451 and a plurality of ink supply ports 452 is formed in correspondence to each of the nozzles. A reservoir 453 is a liquid storing chamber which supplies the ink stored in the ink cartridge to each of the pressure chambers 451 and communicates with the other end of each of the corresponding pressure chambers 451 through the ink supply port 452. In addition, the ink supplied from the ink cartridge is introduced into the reservoir 453 through the ink supply pipe 433. The elastic plate 47 has diaphragms 471. Moreover, the elastic plate 47 also has compliance portions 472 sealing one opening surfaces of an empty portion which is the reservoir 453. In the elastic plate 47, a support plate is subjected to etching and the support plate is removed so that island portions 473 remain. Front ends of free end portions of the piezo elements 421 are adhered to the island portions 473.

Each of the driving units 42 is inserted into the hollow receiving portion 431 in a state where the free ends of the piezo elements 421 face toward the flow passage unit 44, and adhered to the island portions 473 corresponding to the front end surfaces of the free ends. A rear surface of the fixing plate which is a side opposed to an adhesion surface of the piezo elements is adhered to an inner wall surface of the case 43 which partitions the hollow receiving portions 431. When a driving signal is supplied to the piezo elements 421 through the flexible cable 424 in the reception state, the piezo elements 421 expand and contract the volumes of the pressure chambers 451 by expansion and contraction thereof. Pressure varies in the ink of the pressure chambers 451 in accordance with variation in the volume of the pressure chambers 451. In addition, by using the variation in the pressure of the ink, it is possible to eject ink droplets from the nozzles.

Next, for easy understanding of the embodiments, first, a reference example will be described and then the embodiments will be described.

Head Control Unit HC according to Reference Example

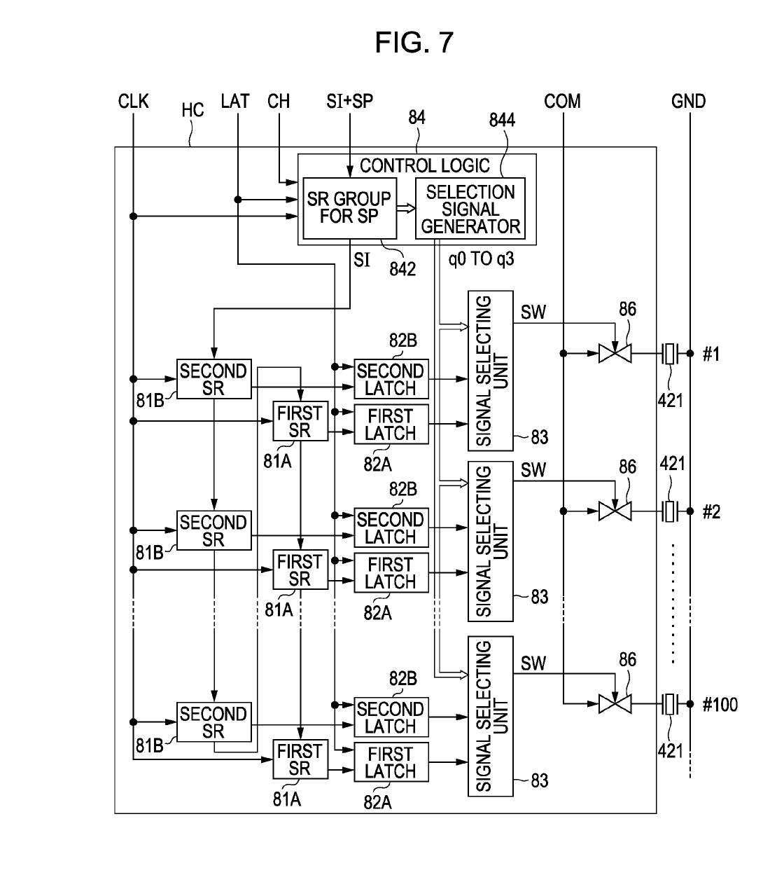

FIG. 7 is a block diagram illustrating the head control unit HC according to the reference example. The head control unit HC includes first shift resistors 81A, second shift resistors 81B, first latch circuits 82A, second latch circuits 82B, signal selecting units 83, a control logic 84, and switches 86. The respective constituent elements (that is, the first shift resistor 81A, the second shift resistor 81B, the first latch circuit 82A, the second latch circuit 82B, the signal selecting unit 83, and the switch 86) other than the control logic 84 are provided in each of the piezo elements 421. The control logic 84 includes a shift resister group 842 storing setting data SP and selection signal generator 844 generating selection signals q0 to q3 on the basis of the setting data SP.

A clock CLK, a latch signal LAT, a change signal CH, and the driving signal COM are input from the printer controller 60 to the head control unit HC through cables. A setting signal containing pixel data SI and the setting data SP are also input from the printer controller 60 to the head control unit HC through the cables.

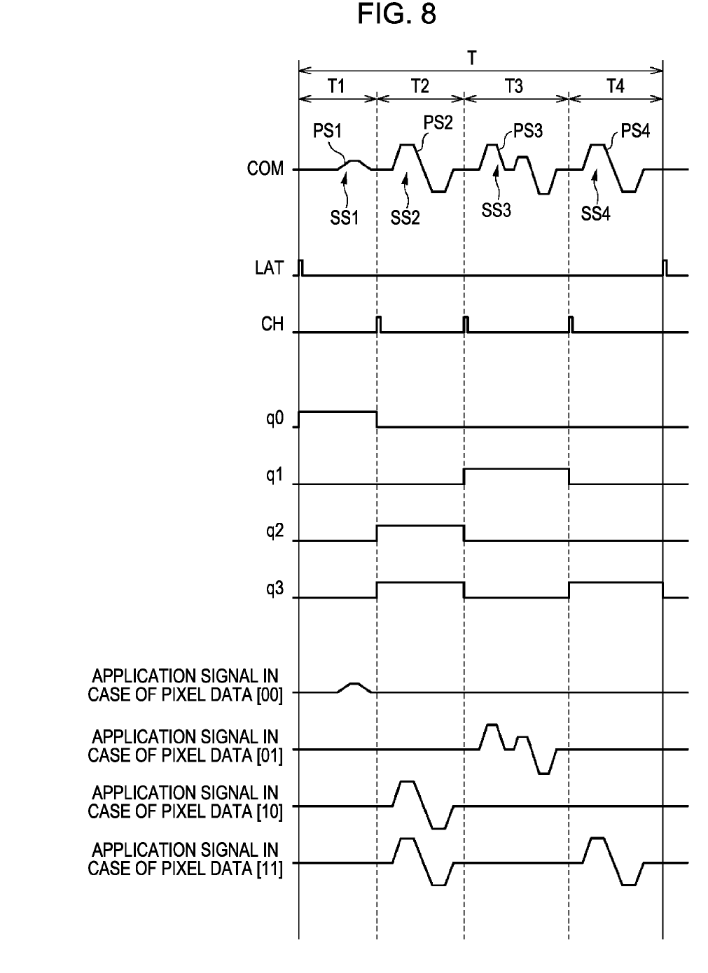

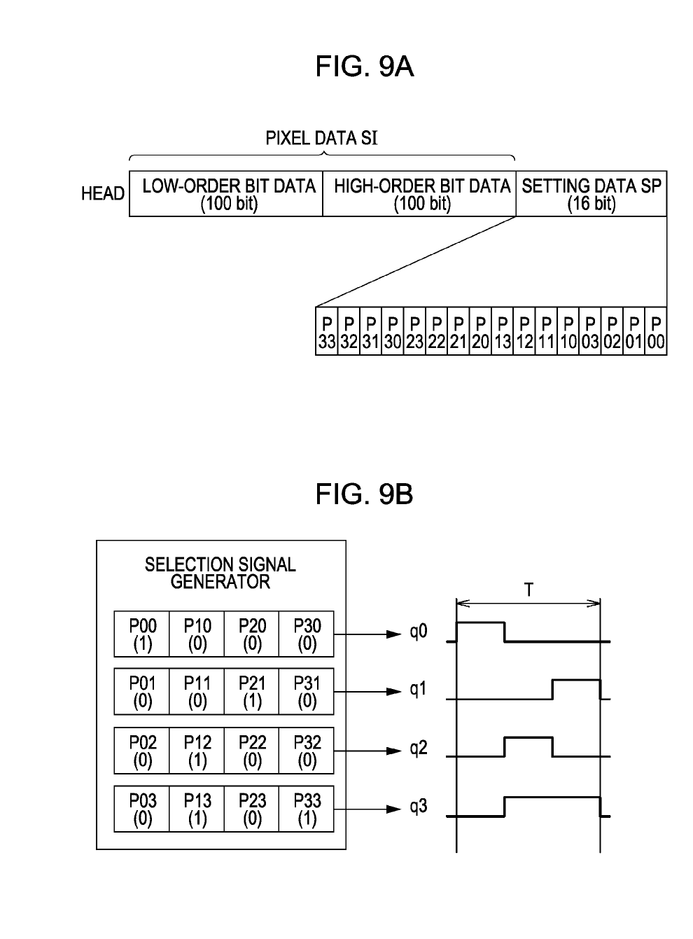

FIG. 8 is an explanatory diagram illustrating the driving signal COM and various signals. FIG. 9A is an explanatory diagram illustrating the setting signal containing the pixel data SI and the setting data SP. FIG. 9B is an explanatory diagram illustrating a function of the selection signal generator 844.

When the setting signal as shown in FIG. 9A is input to the head control unit HC in synchronization with the clock CLK, low-order bit data in the setting signal is set in the first shift resisters 81A, high-order bit data in the setting signal is set to the second shift resistors 81B, and the setting data SP in the setting signal is set in the shift resister group 842 of the control logic 84. In addition, a low-order bit of 2-bit pixel data corresponding to each of the nozzles is set in the first shift resistor 81A and a high-order bit of the 2-bit pixel data is set in the second shift resistor 81B.

In accordance with pulses of the latch signal LAT, the low-order bit data is latched in the first latch circuit 82A, the high-order bit data is latched in the second latch circuit 82B, and the setting data SP is latched in the selection signal generator 844. In addition, the low-order bit of the 2-bit pixel data corresponding to each of the nozzles is latched in the first latch circuit 82A and the high-order bit of the 2-bit pixel data is latched in the second latch circuit 82B.

The setting data SP according to the reference example is configured as 16-bit data (see FIG. 9A). The selection signal generator 844 generates the selection signal q0 on the basis of predetermined 4-bit data (data P00, data P10, data P20, data P30) in the 16-bit setting data SP and the change signal CH. Likewise, the selection signal generator 844 generates the selection signals q1 to q3 on the basis of predetermined 4-bit data in the 16-bit setting data SP and the change signal CH.

According to the reference example, in the 16-bit setting data SP, data P00, data P12, data P13, data P21, and data P33 are [1] and the other data are [0]. Accordingly, 4-bit data (data P00, data P10, data P20, and data P30) for the selection signal q0 becomes [1000]. In consequence, the selection signal q0 becomes an H level at a first interval T1 and becomes an L level at a second interval T2 to a fourth interval T4, as shown in FIG. 8. Likewise, the same is applied to the selection signals q1 to q3, as illustrated.

The signal selection unit 83 selects one of the selection signals q0 to q3 depending on the 2-bit pixel data latched in the first latch circuit 82A and the second latch circuit 82B. When the pixel data is [00] (the low-order bit is [0] and the high-order bit is [0]), the selection signal q0 is selected. When the pixel data is [01], the selection signal q1 is selected. When the pixel data is [10], the selection signal q2 is selected. When the pixel data is [11], the selection signal q3 is selected. Each of the selected selection signals is output as a switch signal SW from the signal selection unit 83.

The driving signal COM and the switch signal SW are input to each of the switches 86. When the switch signal SW is in the H level, the switch 86 is turned ON and the driving signal COM is applied to each of the piezo elements 421. When the switch signal SW is in the L level, the switch 86 is turned OFF and the driving signal COM is not applied to each of the piezo elements 421.

When the pixel data is [00], the selection signal q0 causes the switch 86 to be turned ON or OFF, as shown in FIG. 8, a first section signal SS1 of the driving signal COM is applied to the piezo element 421 and the piezo element 421 is driven by a driving pulse PS1. When the piezo element 421 is driven in accordance with the driving pulse PS1, a pressure variation occurs in ink so as not to eject the ink and an ink meniscus (which is a free surface of ink exposed to a nozzle) thus vibrates minutely.

When the pixel data is [01], the selection signal q1 causes the switch 86 to be turned ON or OFF, a third section signal SS3 of the driving signal COM is applied to the piezo element 421 and the piezo element 421 is driven by a driving pulse PS3. When the piezo element 421 is driven in accordance with the driving pulse PS3, a small amount of ink is ejected to form small dots on a sheet.

When the pixel data is [10], the selection signal q2 causes the switch 86 to be turned ON or OFF, a second section signal SS2 of the driving signal COM is applied to the piezo element 421 and the piezo element 421 is driven by a driving pulse PS2. When the piezo element 421 is driven in accordance with the driving pulse PS2, a medium amount of ink is ejected to form medium dots on a sheet.

When the pixel data is [11], the selection signal q3 causes the switch 86 to be turned ON or OFF, the second section signal SS2 and a fourth section signal SS4 of the driving signal COM are applied to the piezo element 421 and the piezo element 421 is driven by the driving pulse PS2 and a driving pulse PS4. When the piezo element 421 is driven in accordance with the driving pulse PS2 and the driving pulse PS4, large dots are formed on a sheet.

### End Nozzles

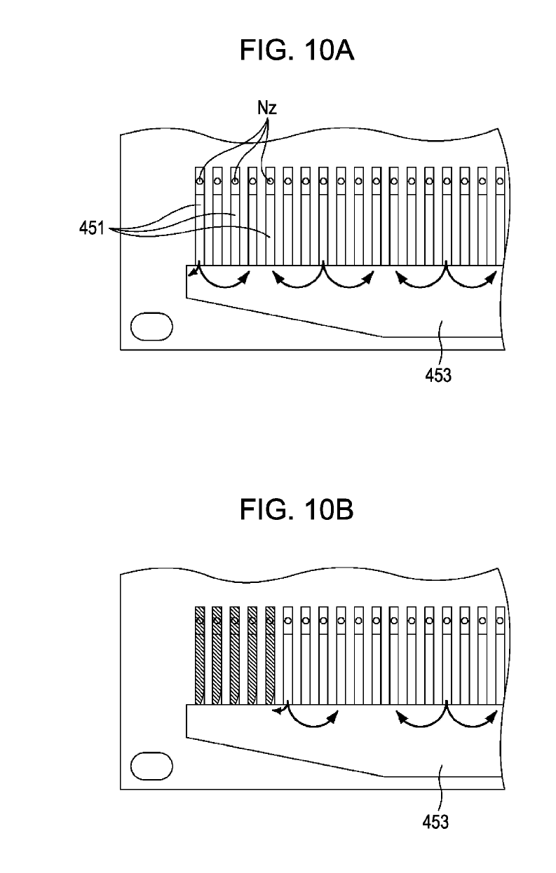

FIG. 10A is an explanatory diagram illustrating flow of the ink stored in the pressure chambers 451 and the reservoir 453 of the head 41. The drawing illustrates the flow passage forming board 45 in FIG. 5 and the constituent elements below the flow passage forming board 45 in the head 41 when viewed from the upside. FIG. 10A shows the reservoir 453, the pressure chambers 451, and the nozzles Nz. It is assumed that the reservoir 453 and the pressure chambers 451 fill with ink. In addition, ink droplets do not leak from the nozzles Nz thanks to a surface tension of the ink, if no force is applied to the pressure chambers 451.

When the pressure chambers 451 are pressed by the island portions 473 from the upside, the pressure of the pressure chambers 451 is increased and the ink droplets are ejected from the nozzles Nz. At this time, some ink droplets are ejected from the nozzles Nz, but some ink flow backward to the reservoir 453. The ink flowing backward to the reservoir 453 slips to the pressure chambers 453 of the adjacent nozzles Nz, when the adjacent nozzles Nz are present. The slipping ink vibrates the ink meniscus of the nozzles and thus the movement of the temporarily slipping ink is absorbed.

However, nozzles (hereinafter, referred to as the outermost nozzles) in the outermost ends of a nozzle row are each adjacent to only one nozzle. Therefore, the adjacent pressure chamber to which the ink slips is only one. However, for example, the nozzles other than the outermost nozzles can send the ink to two pressure chambers, since there are the pressure chambers of the nozzles on both sides. Therefore, since in the nozzles other than the outermost nozzles, there is a difference in areas to which the ink can slip, a travel characteristic of the ink droplets is different between the areas in some cases.

Here, for easy description, the nozzles are simply classified into the outermost nozzles and the other nozzles. However, since the nozzles are very minute elements, ink ejection precision in several nozzles from the outermost nozzles is not preferable in some cases, likewise with the outermost nozzles.

For this reason, in this embodiment, the ink droplets are designed not to be ejected from every five nozzles (#1 to #5 and #96 to #100) from the ends of a nozzle row in order not to form an image, when the image is formed by ejecting the ink droplets on a sheet.

FIG. 10B is an explanatory diagram illustrating ink flow when the nozzles Nz are clogged with ink. When the ink droplets are configured not to be ejected from every five nozzles from the outermost ends of a nozzle row, the ink in these nozzles may be solidified, thereby causing the nozzles Nz to be clogged. When the nozzles are clogged due to the ink, meniscuses of the nozzles do not vibrate. Therefore, the ink cannot slip to the pressure chambers 451 of the clogged nozzles. For this reason, the nozzles adjacent to the clogged nozzles deteriorate ejection precision of the ink droplets, as in the outermost nozzles.

In this way, even the nozzles which are not used upon forming an image may have a bad influence on the ejection precision of the ink droplets ejected from the other nozzles, due to the clogging. In order to solve this problem, the nozzles which are not used upon forming an image have to be configured not to be clogged. Therefore, it is necessary to perform a flushing process on even the nozzles which are not used upon forming an image, as in the nozzles which are used upon forming an image.

The flushing process refers to a process of moving the head 41 to a flushing location and forcing the ink droplets to be ejected from all the nozzles. By eliminating the thickened ink from the nozzles, all the nozzles are prevented from being clogged. In addition, the flushing location refers to a location where the ink droplets are not landed on a sheet as a medium even upon ejecting the ink droplets. Here, the flushing location is provided in the end in the carriage movement direction.

When the flushing process is performed in the configuration according to the above-described reference embodiment, each pixel data SI corresponding to each of the nozzles is set to [11] so as to eject the ink droplet corresponding to the large dot from each of the nozzles, for example.

However, as described above, the ten nozzles in the ends of a nozzle row do not form an image. That is, just by using data used for ejecting the ink droplets in the flushing process and data used for not ejecting the ink droplets upon performing an image, it is possible to sufficiently configure these nozzles not to be clogged. In order words, since all the end nozzles eject the ink droplets or do not eject the ink droplets, it is possible to use commonly one data specifying whether to eject the ink droplets from the nozzles in the ends of a nozzle row. Accordingly, it is possible to reduce an amount of total data to be transmitted to the head 41.

In embodiments described below, it is configured that the head control unit which commonly uses data for the nozzles in the ends of a nozzle row is provided and an amount of data to be transmitted from the printer controller 60 to the head control unit HC is reduced.

### First Embodiment

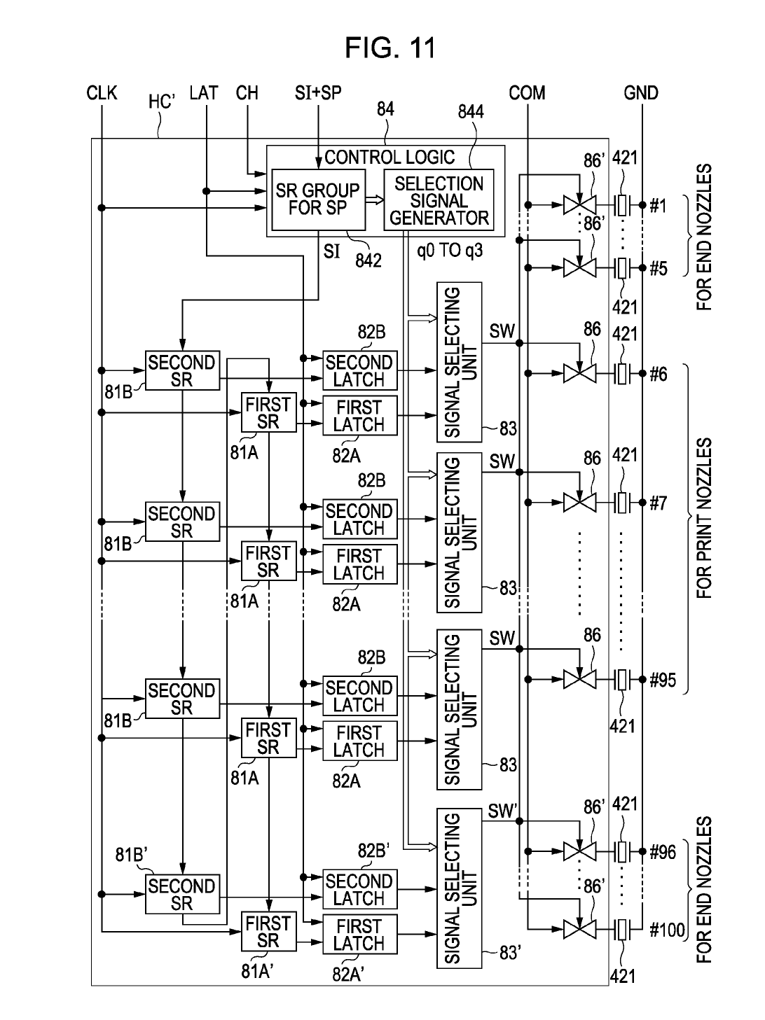

FIG. 11 is a block diagram illustrating a head control unit HC′ according to a first embodiment. In the head control unit HC′ shown in FIG. 11 according to the first embodiment, some constituent elements of the head control unit HC (see FIG. 7) according to the above-described reference embodiment are replaced with constituent elements described below. In addition, the head 41 equipped with the head control unit HC′ corresponds to a head unit.

In the head control unit HC′ according to the first embodiment, all the signal selection units 83, the first latches 82A, the second latches 82B, the first shift resistors 81A, and the second shift resistors 81B corresponding to the end nozzles (#1 to #5 and #96 to #100) are replaced with one group of a signal selection unit 83′, a first latch 82A′, a second latch 82B′, a first shift resistor 81A′, and a second shift resistor 81B′ for the end nozzle. In addition, signal selection units 83, first latches 82A, second latches 82B, first shift resistors 81A, and second shift resistors 81B for the print nozzles (#6 to #95) have the same configuration as those in the reference example.

In the head control unit HC′, individual switches 86′ for the end nozzles are attached to individual piezo elements 421 corresponding to the end nozzles (#1 to #5 and #96 to #100). In addition, in order to commonly control the switches 86′ for all the end nozzles, an output of the signal selection unit 83′ for one end nozzle is connected to the switches 86′ for all the end nozzles.

Functions of the first shift resistor 81A′, the second shift resistor 81B′, the first latch 82A′, the second latch 82B′, the signal selection unit 83′, and the switches 86′ for the end nozzles are the same as those of the first shift resistors 81A, the second shift resistors 81B, the first latches 82A, the second latches 82B, the signal selection units 83, and the switches 86 according to the above-described reference example. Therefore, on the basis of the pixel data SI set to the group of the first shift resistor 81A′ and the second shift resistor 81B′ for the end nozzles, ink droplets are ejected or not ejected commonly from the end nozzles (#1 to #5 and #96 to #100).

With such a configuration, the pixel data SI set to the first shift resistor 81A′ and the second shift resistor 81B′ for the end nozzles are commonly used as pixel data for the end nozzles (#1 to #5 and #96 to #100).

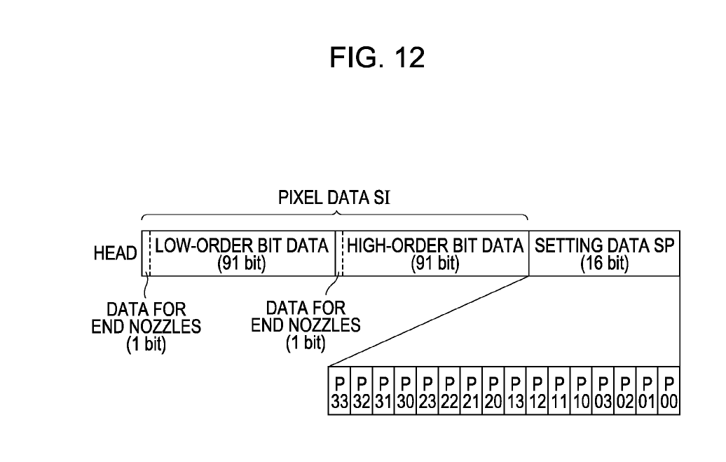

FIG. 12 is an explanatory diagram illustrating the setting signal including the pixel data SI and the setting data SP according to the first embodiment. In FIG. 12, the pixel data SI and the setting data SP are illustrated. The pixel data SI according to the first embodiment contains 91-bit low-order bit data and 91-bit high-order bit data. One bit at the head of the low-order bit data is used as low-order pixel data SI for the end nozzles (#1 to #5 and #96 to #100). One bit at the head of the high-order bit data is used as high-order pixel data SI for the end nozzles (#1 to #5 and #96 to #100).

The one bit at the head of the low-order bit data is set in the first shift resistor 81A′ and the one bit at the head of the high-order bit data is set in the second shift resistor 81B′. The one bit at the head of the low-order bit data and the one bit at the head of the high-order bit data are set in the first latch 82A′ and the second latch 82B′ by the latch signal LAT, respectively. In addition, the values thereof are transmitted to the signal selection unit 83′.

The bit values set in the first shift resistor 81A′ and the second resistor 81B′ are set to all “0” or “1” in the first shift resistor 81A′ and the second shift resistor 81B′. Accordingly, the signal selection unit 83′ commonly controls the switches 86′ for the end nozzles so as not to eject the ink droplets from the end nozzles (#1 to #5 and #96 to #100) or so as to eject the ink droplets to form the large dots.

Upon forming an image, “0” is set to both the one bit at the head of the low-order bit data and the one bit at the head of the high-order bit data. In this way, upon forming a normal image, it is possible not to eject the ink droplets from the end nozzles (#1 to #5 and #96 to #100). On the other hand, upon performing the flushing process, “1” is set to both the one bit at the head of the low-order bit data and the one bit at the head of the high-order bit data. In this way, upon performing the flushing process, it is possible to eject the ink droplets from the end nozzles (#1 to #5 and #96 to #100) so as to form the large dots. Moreover, it is possible to discharge the thickened ink in the nozzles.

The one-bit pixel data of the low-order bit data and the one-bit pixel data of the high-order bit data are set as the pixel data SI commonly used for the end nozzles (#1 to #5 and #96 to #100). The low-order bit data and the high-order bit data for the print nozzles (#6 to #95) each have 90 bits. Accordingly, the pixel data SI has 182 bits (91 bits (low-order bit data)+91 bits (high-order bit data)). In addition, the setting data SP has 16 bits, as in the setting data according to the reference example. Therefore, a total amount of data of the setting signal is 198 bits.

With such a configuration, the pixel data SI for the end nozzles can be commonly used. In addition, the amount of data of the setting signal is reduced (reduced from 216 bits to 198 bits). Accordingly, it is possible to reduce the amount of data to be transmitted from the printer controller 60 to the head control unit HC′.

### Second Embodiment

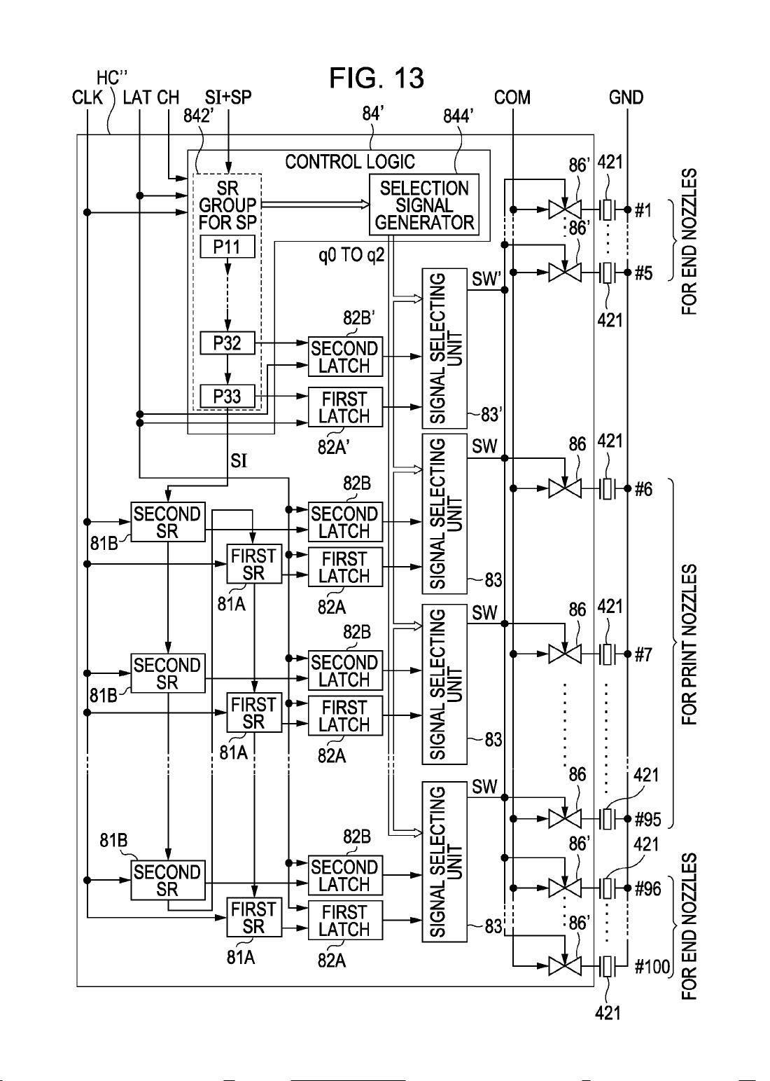

FIG. 13 is a block diagram illustrating a head control unit HC″ according to a second embodiment. In the head control unit HC″ shown in FIG. 13 according to the second embodiment, some constituent elements of the head control unit HC (see FIG. 7) according to the above-described reference example are replaced with constituent elements described below.

In the head control unit HC″ according to the second embodiment, the control logic 84 is replaced with a control logic 84′ according to the second embodiment. In addition, in the head control unit HC″, the signal selection units 83, the first latches 82A, the second latches 82B, the first shift resistors 81A, and the second shift resistors 81B corresponding to all the end nozzles (#1 to #5 and #96 to #100) are all replaced with a group of a signal selection unit 83′, a first latch 82A′, a second latch 82B′, a first shift resistor 81A′, and a second shift resistor 81B′ for the print nozzles. In addition, signal selection units 83, first latches 82A, second latches 82B, first shift resistors 81A, and second shift resistors 81B for the print nozzles (#6 to #95) have the same configuration as those in the reference example.

In the head control unit HC″ according to the second embodiment, individual switches 86′ for the end nozzles are attached to individual piezo elements 421 corresponding to the end nozzles (#1 to #5 and #96 to #100). In addition, in order to commonly control the switches 86′ for all the end nozzles, an output of one signal selection unit 83′ is connected to the switches 86′ for all the end nozzles.

The control logic 84′ has a configuration in which a head bit (P33) and a second bit (P32) set in a shift resister group for setting data SP are latched in the first latch 82A′ and the second latch 82B′, respectively.

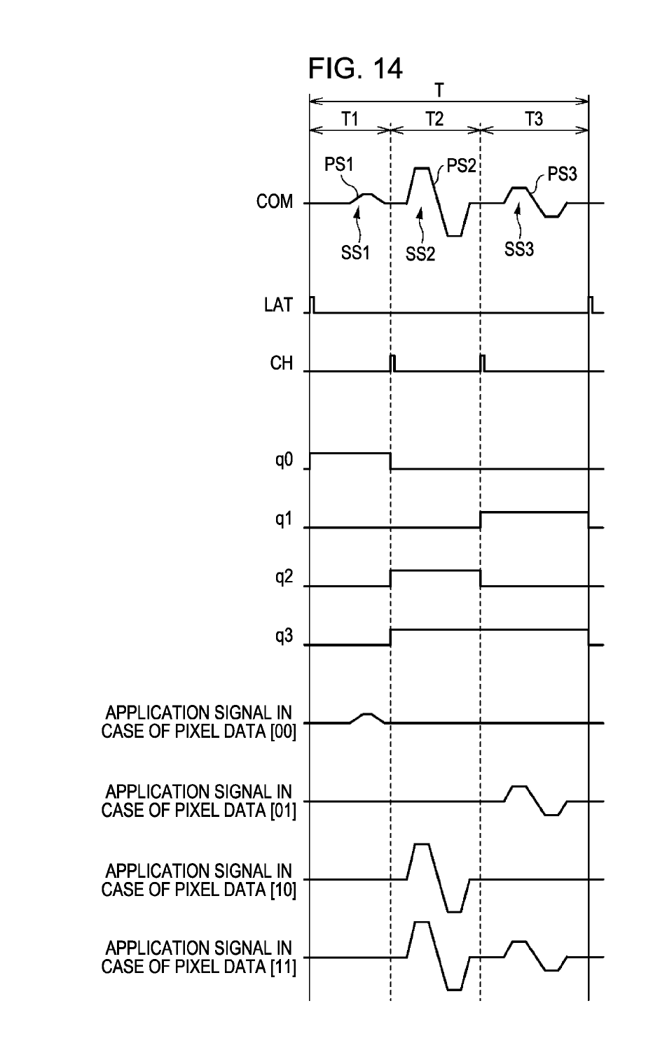

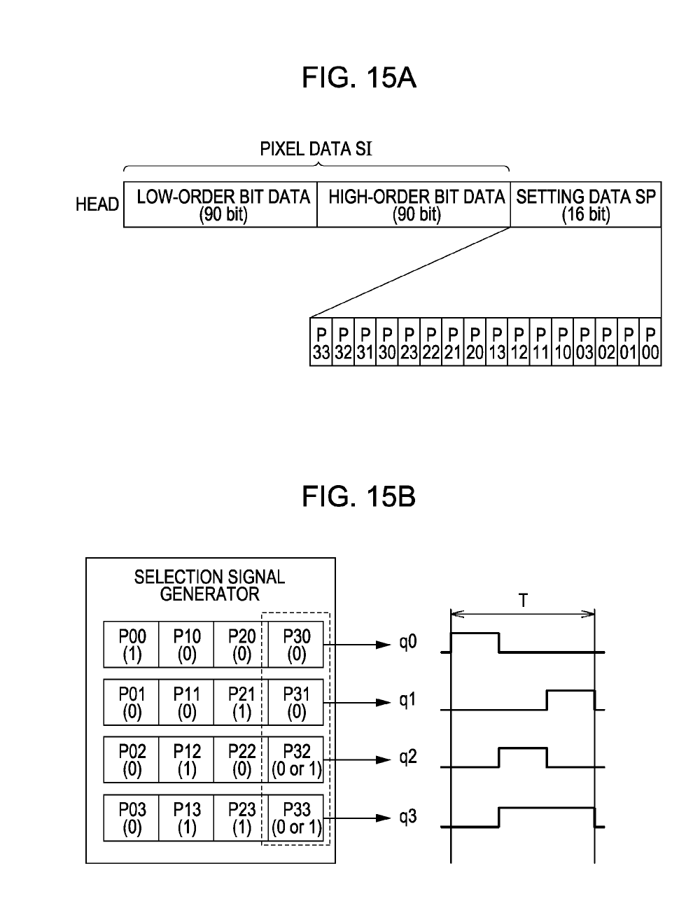

FIG. 14 is an explanatory diagram illustrating a driving signal COM and various signals according to the second embodiment. FIG. 15A is an explanatory diagram illustrating a setting signal including pixel data SI and setting data SP according to the second embodiment. FIG. 15B is an explanatory diagram illustrating a function of a selection signal generator 844′ according to the second embodiment.

The driving signal COM according to the second embodiment is constituted by a first driving pulse PS1 to a third driving pulse PS3 in a first section signal SS1 to a third section signal SS3, respectively. As described below, the ink droplets are not ejected, when only the first driving pulse PS1 is applied to the piezo elements 421. In addition, the ink droplets for forming small dots are ejected, when only the third driving pulse PS3 is applied to the piezo elements 421. The ink droplets for forming medium dots are ejected, when only the second driving pulse PS2 is applied to the piezo elements 421. The ink droplets for forming large dots are ejected, when the second driving pulse PS2 and the third driving pulse PS3 are applied to the piezo elements 421. In this way, no dot, the small dots, the medium dots, and the large dots are formed by combination of the three driving pulses.

Since no dot, the small dots, the medium dots, and the large dots can be formed by combination of the three driving pulses, it is possible to generate one selection signal with three bits. Therefore, the selection signal generator 844′ according to the second embodiment generates a selection signal q0 on the basis of 3-bit data (data P00, data P10, and data P20) and a change signal CH in the 16-bit setting data SP. Likewise, the selection signal generator 844′ generates selection signals q0 to q3 on the basis of 3-bit predetermined data and the change signal CH in the 16-bit setting data.

In the second embodiment, data P32 and data P33 in the 16-bit setting data SP are used as data for determining whether to eject the ink droplets from the end nozzles (#1 to #5 and #96 to #100). Since data P30 and data P31 are not used, the data P30 and the data P31 are fixed to [0]. Data P00, data P12, and data P21 are set to [1] and the other data are set to [0]. Accordingly, the 3-bit data (data P00, data P10, and data P20) for the selection signal q0 is set to [100], and thus the selection signal q0 becomes an H level at a first interval T1 and becomes an L level at a second interval T2 and a third interval T3. In addition, the selection signals q1 to q3 become signals illustrated in the drawings.

Each of the signal selection units 83 of the print nozzles (#6 to #95) selects one of the selection signals q0 to q3 depending on 2-bit pixel data latched in the first latch 82A and the second latch 82B. When the pixel data is [00] (when a low-order bit is [0] and a high-order bit is [0]), the selection signal q0 is selected. When the pixel data is [01], the selection signal q1 is selected. When the pixel data is [10], the selection signal q2 is selected. When the pixel data is [11], the selection signal q3 is selected. The selected selection signal is output as a switch signal SW from each of the signal selection units 83.

When the pixel data is [00], the selection signal q0 causes each of the switches 86 to be turned ON or OFF, the first interval signal SS1 of the driving signal COM is applied to each of the piezo elements 421, and each of the piezo elements 421 is driven by the driving pulse PS1. When each of the piezo elements 421 is driven in accordance with the driving pulse PS, a pressure variation occurs in the ink so as not to eject the ink and an ink meniscus thus vibrates minutely.

When the pixel data is [01], the selection signal q1 causes each of the switches 86 to be turned ON or OFF, the third section signal SS3 of the driving signal COM is applied to each of the piezo elements 421 and each of the piezo elements 421 is driven by a driving pulse PS3. When the piezo element 421 is driven in accordance with the driving pulse PS3, the small amount of ink is ejected to form the small dots on a sheet.

When the pixel data is [10], the selection signal q2 causes each of the switches 86 to be turned ON or OFF, the second section signal SS2 of the driving signal COM is applied to each of the piezo elements 421 and each of the piezo elements 421 is driven by a driving pulse PS2. When each of the piezo elements 421 is driven in accordance with the driving pulse PS2, the medium amount of ink is ejected to form the medium dots on a sheet.

When the pixel data is [11], the selection signal q3 causes each of the switches 86 to be turned ON or OFF, the second section signal SS2 and the third section signal SS3 of the driving signal COM are applied to each of the piezo elements 421 and each of the piezo elements 421 is driven by the driving pulse PS2 and the driving pulse PS3. When each of the piezo elements 421 is driven in accordance with the driving pulse PS2 and the driving pulse PS3, the large dots are formed on a sheet.

Next, ejection of the ink droplets from the end nozzles (#1 to #5 and #96 to #100) will be described. When the setting data SP is set in the shift resistor groups for the setting data SP, a latch signal LAT causes the one bit (P33) at the head of the setting data SP to be transmitted to the first latch 82A′ and causes the second bit (P32) from the head of the setting data SP to be transmitted to the second latch 82B′. Subsequently, these values are transmitted to the signal selection unit 83′.

Bit values to be set in P33 and P32 of the setting data SP are all [0] or all [1]. Therefore, the signal selection unit 83′ commonly controls the switches 86′ so as not to eject the ink droplets from the end nozzles (#1 to #5 and #96 to #100) or so as to eject the ink droplets in order to form the large dots.

Upon forming an image, P33 and P32 of the setting data SP are all set to [0]. With such a configuration, upon forming the image, it is possible not to eject the ink droplets from the end nozzles (#1 to #5 and #96 to #100). On the other hand, upon performing the flushing process, P33 and P32 of the setting data SP are all set to [1]. In this way, upon performing the flushing process, it is possible to discharge the ink by ejecting the ink droplets for forming the large dots from the end nozzles (#1 to #5 and #96 to #100). Therefore, it is possible to discharge the solidified ink in the nozzles.

By realizing the above-described configuration, the data to be used to control the end nozzles can be contained in the setting data SP. In addition, the amount of data of the setting signal can be reduced (reduced from 216 bits to 196 bits). Accordingly, it is possible to reduce the amount of data to be transmitted from the printer controller 60 to the head control unit HC″.

This embodiment also has advantages as follows. Suppose that a printer uses a head of one row with ninety nozzles and all the ninety nozzles of one row are used to eject ink droplets in the printer. Then, the printer is designed so as to modify the nozzle configuration into a configuration of one row with hundred nozzles to improve an image quality by not ejecting the ink droplet from the end nozzles. If data transmission is performed using the method according to the reference example, the number of bits of data to be transmitted has to be increased by the number of the nozzles. However, the head according to the embodiments may use the same data as that in FIG. 15A for transmission. The data transmission is normally performed by an exclusive control IC, but a known printer just transmits data corresponding to one row with ninety nozzles to match with the head. Moreover, when this control IC is newly devised to match with the head having the increased number of nozzles, considerable development cost and time are necessary (considerable cost is necessary to devise the exclusive control IC having numerous functions to be used in a printer). However, when a head having the head control unit HC″ according to this embodiment is used, the control IC of the known printer is also used, and thus the considerable development cost is not necessary.

### Other Embodiments

In the above-described embodiments, the printer 1 equipped with the head unit has been described, but the invention is not limited thereto. The invention may be realized in liquid ejecting apparatus capable of ejecting or spraying other liquids (a liquid, a liquid-formed substance in which particles of a functional material are dispersed, or a fluid-formed substance such as gel) in addition to ink. For example, the same technique as that in the above-described embodiment may be applied to various apparatuses to which an ink jet technique is applied, such as a color filter manufacturing apparatus, a dyeing apparatus, a micro processing apparatus, a semiconductor manufacturing apparatus, a surface processing apparatus, a three-dimensional modeling apparatus, an evaporation apparatus, an organic EL manufacturing apparatus (particularly, a polymer EL manufacturing apparatus), a display manufacturing apparatus, a coating apparatus, and a DNA chip manufacturing apparatus. In addition, the above-described method and a manufacturing method are also applicable.

It should be understood that the foregoing embodiments have been described for easy understanding of the invention and are not to be considered as limiting. The invention may be modified and improved without departing the gist of the invention and the equivalents of the invention are also included. In particular, an embodiment described below is also included in the invention.

### Head

In the above-described embodiments, ink is ejected using the piezo elements. However, the method of ejecting a liquid is not limited thereto. For example, another method such as a method of generating bubbles within nozzles by heating may be used. In addition, the invention is not limited to the carriage scanning type printing apparatus in the embodiments, but a line printer may be used. Here, the line printer refers to a printer equipped with a head which has nozzle rows in which a plurality of nozzles are arranged in a direction orthogonal to a sheet transport direction. In addition, the line printer does not move the head in principle, but perform printing by continuously ejecting ink droplets while transporting a sheet.

What is claimed is:

1. A head unit comprising:
a first nozzle group which has a plurality of nozzles ejecting liquid droplets onto a medium to form an image;
a second nozzle group which has a plurality of nozzles which do not eject liquid droplets onto the medium, while the nozzles of the first nozzle group eject the liquid droplets onto the medium to form the image; and
a controller which determines whether to eject the liquid droplets from each of the nozzles of the first nozzle group on the basis of data individually corresponding to the nozzles of the first nozzle group and which commonly determines whether to eject the liquid droplets from the nozzles of the second nozzle group on the basis of data commonly corresponding to the nozzles of the second nozzle group.

2. The head unit according to claim 1, wherein the controller includes switches for the second nozzle group for commonly applying a driving signal to driving elements individually corresponding to the nozzles of the second nozzle group, and the switches for the second nozzle group are commonly controlled on the basis of the data commonly corresponding to the nozzles of the second nozzle group.

3. The head unit according to claim 1, wherein the controller includes switches for the first nozzle group for applying a driving signal to driving elements individually corresponding to the nozzles of the first nozzle group, and each of the switches for the first nozzle group is controlled on the basis of the data individually corresponding to the nozzles of the first nozzle group.

4. The head unit according to claim 1, wherein the data individually corresponding to nozzles of the first nozzle group and the data commonly corresponding to the nozzles of the second nozzle group are pixel data.

5. The head unit according to claim 1,
wherein the data individually corresponding to the nozzles of the first nozzle group are pixel data, and
wherein the data commonly corresponding to the nozzles of the second nozzle group is data contained in setting data used to determine whether a certain waveform in a driving signal is applied to driving elements of the second nozzle group on the basis of the pixel data.

6. The head unit according to claim 1, wherein the first nozzle group and the second nozzle group are arranged in the same nozzle row.

7. The head unit according to claim 6, wherein the nozzles of the second nozzle group are arranged in ends of the same nozzle row.

8. A liquid ejecting method comprising:
determining whether to eject liquid droplets from each of nozzles of a first nozzle group, which eject the liquid droplets onto a medium to form an image, on the basis of data individually corresponding to the nozzles of the first nozzle group, and commonly determining whether to eject liquid droplets from nozzles of a second nozzle group, which do not eject the liquid droplets onto the medium while the nozzles of the first nozzle group form the image, on the basis of data commonly corresponding to the nozzles of the second nozzle group; and
ejecting the liquid droplets from the nozzles of the first nozzle group and the nozzles of the second nozzle group on the basis of the determination result.
